(19) United States
(12) Patent Application Publication
(10) Pub. No.: US 2002/0124125 A1
(43) Pub. Date: Sep. 5, 2002

(54) Method and apparatus to permit a peripheral device to become the default system bus master

(76) Inventors: David Bormann, Sunnyvale, CA (US); Leslie E. Cline, Sunnyvale, CA (US); Frank Hart, Apex, NC (US); Siripong Sritanyaratana, Union City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/751,427

(22) Filed: Dec. 29, 2000

(51) Int. Cl. G06F 13/00

(52) U.S. Cl. 710/110

(57) ABSTRACT

A method and apparatus for facilitating direct access to computer resources by a peripheral device while the computer's CPU is in a sleeping state. Said method and apparatus comprising a configurable link to enable a peripheral device to become the default system bus master when the main CPU is in a sleep state.

### FIELD

The present invention relates generally to a method and apparatus to allow a computer system to receive information while the CPU is in a sleeping state, and more particularly to a configurable link or bus with multiple modes of operation that facilitate a peripheral device to become the default bus master for a system while system's CPU is in a sleeping or suspended state.

### BACKGROUND OF THE INVENTION

As mobile computing devices seek to extend time-of-operation between battery charges, power management has become increasingly important. One way in which power management is accomplished is by completely, or partially, shutting down computer components, such as the central processing unit (CPU), hard disk drive, display, and other input/output (I/O) devices, when the computer is not performing operations.

During some of these power management modes, also known as sleeping states, the computer's CPU may cease communications with and control of its peripheral resources, including I/O components, and those resources may not be accessible to any other computer component. Such power management techniques are not unique to any one computer system architecture.

One hardware system specification, the Advanced Configuration and Power Interface (ACPI) Specification, by Intel, Microsoft, and Toshiba, Revision 1.0b, Feb. 2, 1999, provides enhanced power management in a personal computer (PC) system architecture. The ACPI Specification describes the transfer of power management functions from the Basic Input/Output System (BIOS) to the operating system, thereby enabling demand-based peripheral and power management. Through the application of this specification, PC computers manage power usage of peripheral devices such as CD-ROMs, network cards, hard disk drives, codecs, and printers, as well as consumer electronics connected to a PC, such as video cassette recorders, television sets, telephones, and stereos.

ACPI provides several low-power sleeping states, S1-S5, that reduce the power consumed by the platform by limiting the operations it may perform. These sleeping states are described in the table below; S0 has been added as an indicator of the ‘active’ or ‘no sleeping state’. These various operating states are herein referred to as power management states. ‘Context’, as used in the table below, refers to variable data held by the CPU and other computer devices. It is usually volatile and can be lost when entering or leaving certain sleeping states.

| Sleeping | |
|---|---|
| States | Description |
| S0 | Normal operation, active state (no sleeping state). |
| S1 | The S1 sleeping state is a low wake-up latency sleeping state. |
| | In this state, no system context is lost (CPU or chip set) and |
| | hardware maintains all system context. |
| S2 | The S2 sleeping state is a low wake-up latency sleeping state. |
| | This state is similar to the S1 sleeping state except the CPU |
| | and system cache context is lost (the OS is responsible for |
| | maintaining the caches and CPU context). Control starts from |
| | the processor's reset vector after the wake-up event. |
| S3 | The S3 sleeping state is a low wake-up latency sleeping state |
| | where all system context is lost except system memory. CPU, |
| | cache, and chip set context are lost in this state. Hardware |
| | maintains memory context and restores some CPU and L2 |
| | configuration context. Control starts from the processor's |
| | reset vector after the wake-up event. |
| S4 | The S4 sleeping state is the lowest power, longest wake-up |
| | latency sleeping state supported by ACPI. In order to reduce |
| | power to a minimum, it is assumed that the hardware platform |
| | has powered off all devices. A copy of the platform context is |
| | written to the hard disk. |
| S5 | The S5 state is similar to the S4 state except the OS does not |
| | save any context nor enable any devices to wake the system. |
| | The system is in the “soft” off state and requires a complete |
| | boot when awakened. |

In many computing architectures, including the PC computing architecture, data may only be transferred between two peripheral devices by having the host operating system manage such transfer. That is, the processing system or CPU, through one of its auxiliary components, functions as a “master” controlling the data flow to, from, and among peripheral devices which function as “slaves”. The “master” is also commonly referred to as the “bus master”.

FIG. 1A is a system level diagram of a conventional computing architecture. Generally, the Processing System 100 acts as the “master” by directly or indirectly controlling communications to, from, and among peripheral devices 116, 118, and 134. A component, such as the Processing System 100, which acts as the “master” for managing data flow is often also referred to as the “default bus master”. The Processing System 100 is typically communicatively coupled to the peripheral devices 116, 118, and 134 via a bus 112. Often, an I/O Hub 130 is employed to couple the bus 112 the one or more peripheral devices 116, 118, and 134 and route data therebetween as indicated by the bi-directional dashed lines. The I/O Hub 130 and the peripheral devices 116, 118, and 134 are usually communicatively coupled by secondary buses 114, 120, and 132.

In most computing architectures, the peripheral devices 116, 118, and 134 cannot operate without the management of the Processing System 100. Thus, while the Processing System 100 is in certain power management states, such as a sleeping or suspended state, the peripheral devices 116, 118, and 134 may not transmit or receive data to or from the Processing System 100 or other peripheral devices.

In another example, FIG. 1B illustrates a system-level diagram of relevant components of the PC computing architecture. In this architecture, the I/O Controller Hub (ICH) 180, under the control of the CPU 152, manages communications to, from, and among peripheral devices 166, 168, 184 by controlling data flow to the Memory Controller Hub (MCH) 150. The bus 162 between the ICH 180 and MCH 150 is known as the Hub Link bus 162. The MCH 150 may store data received from the ICH 180 in memory (RAM) 160 and the CPU 152 may access such data via the MCH 150.

The ICH 180 communicates with various peripheral devices 166, 168, 184 and I/O components via standard buses or interfaces 164, 170, and 182. For instance, the computer's hard disk drive (HDD) 168 may be communicatively coupled to the ICH 180 via an Integrated Drive Electronics (IDE) or Extended IDE (EIDE) interface 170. “Coupled” as used herein includes electrically coupling two or more components. The ICH 180 may also communicate with an audio codec (AC'97) 166 through an AC'97 Link 164. Other peripheral devices may also be interfaced with the ICH 180 through such interfaces as a Peripheral Component Interconnect (PCI), Universal Serial Bus (USB), RS-232 serial port, or parallel port.

Regardless of the interface or peripheral device, the ICH 180 routes data, indicated by the dashed bidirectional lines, between said interface or device and the MCH 150 as indicated in FIG. 1B. The host computer's operating system (OS) acts as the default Hub Link bus master when the CPU 152 is not in a sleeping or suspended state.

While a number of devices are capable of becoming bus masters, only the Processing System 100 (FIG. 1A) or main CPU 152 (FIG. 1B) can serve as the default bus master. That is, the host computer's operating system, executed by the Processing System 100 or CPU 152, operates as the default bus master and may select a peripheral device to function a bus master while the CPU 152 is not in a sleeping or suspended state. While the Processing System 100 or CPU 152 are in these sleeping states S3-S5, their resources are often unavailable and communications with the computer and its peripheral devices is not generally possible without disturbing the Processing System 100 or CPU 152. Typically, the I/O Hub 130 (FIG. 1A) or ICH 180 (FIG. 1B) are designed with a single Hub Link interface and can handle only one default bus master.

Thus, in the architectures of FIGS. 1A and 1B, peripheral devices may not communicate with other peripheral devices, and the system cannot receive data while the Processing System 100 or CPU 152 is in a sleeping or suspended state, without disturbing the Processing System 100 or CPU 152.

Accordingly, there is a need for a means to allow a peripheral device to access other peripheral devices while a host computer's Processing System or CPU is in a sleeping or suspended state without disturbing the sleeping or suspended state of the Processing System or CPU.

### BRIEF DESCRIPTION OF THE DRAWINGS

FIG. 1A is a system-level diagram of a conventional computing architecture.

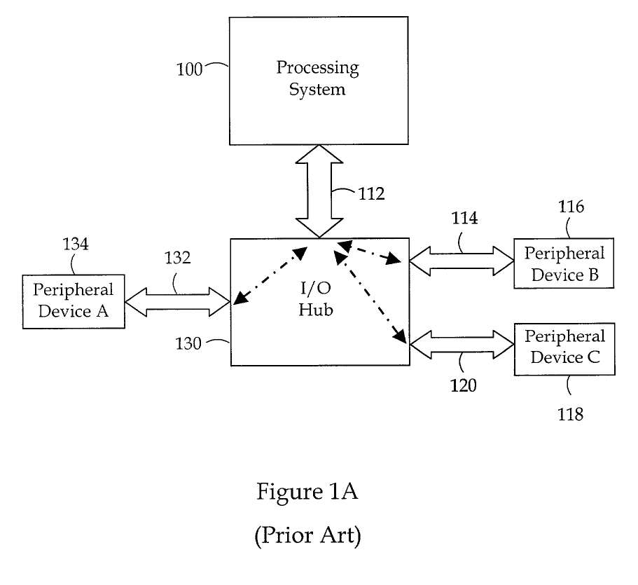

FIG. 1B illustrates the computing architecture of a conventional PC system.

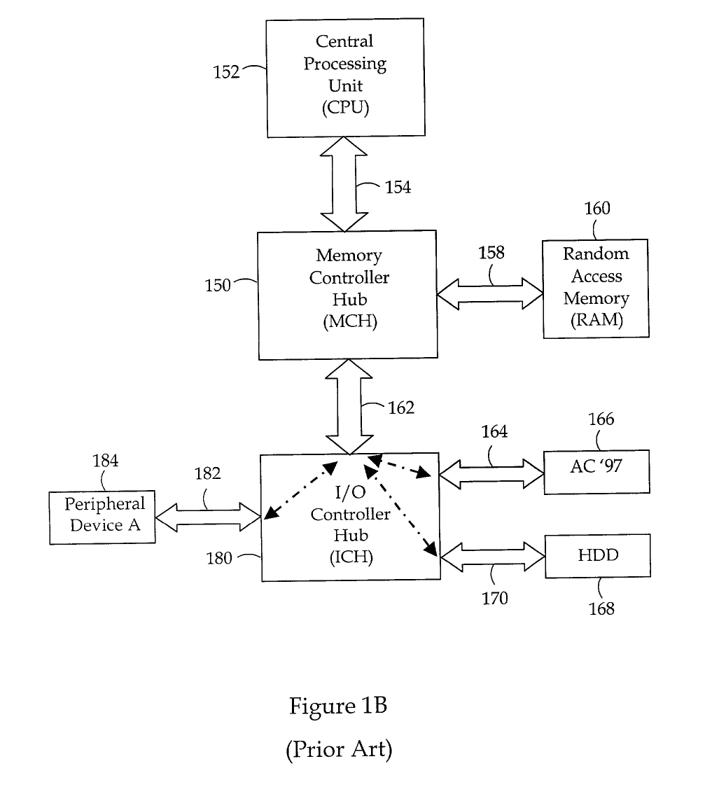

FIG. 2A is a system-level diagram illustrating the data flow between computer system components in a first operating state of the invention.

FIG. 2B is a system-level diagram illustrating the data flow between computer system components in a second operating state of the invention.

FIG. 3A is a system-level diagram illustrating data flow between PC computer components during normal operation.

FIG. 3B is a system-level diagram illustrating data flow between a peripheral device and computer components when a PC computer is in a sleeping or suspended state.

FIG. 4 is a system-level diagram of one embodiment of the peripheral device of the present invention.

FIG. 5 is a high-level flowchart of the peripheral device's operation.

### DETAILED DESCRIPTION OF THE INVENTION

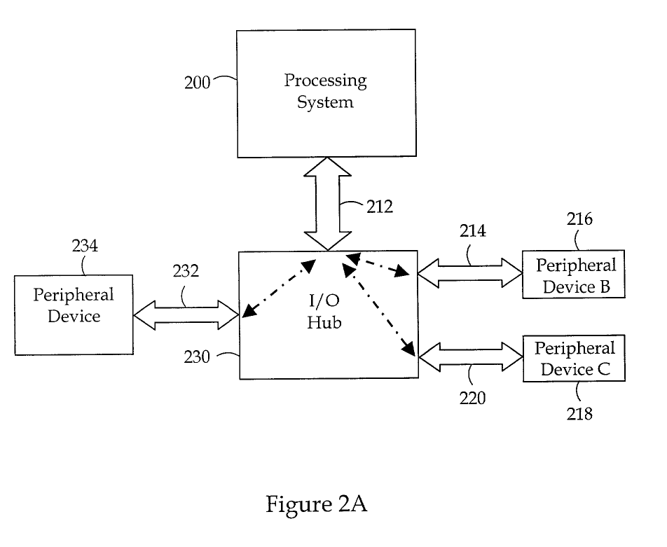

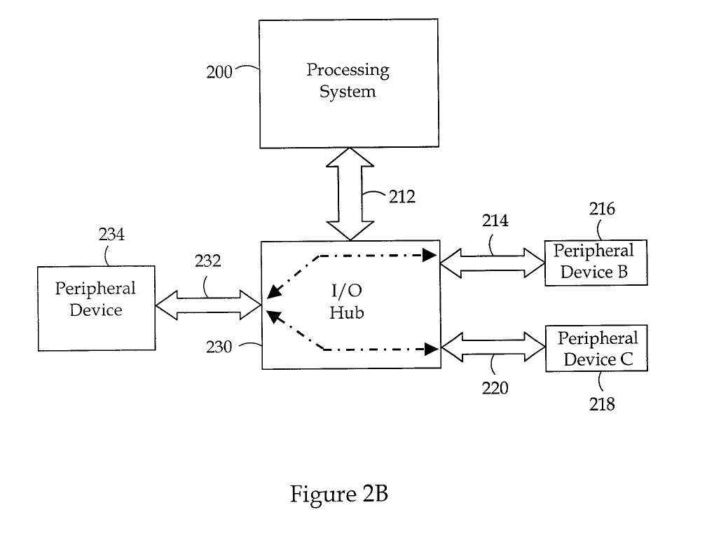

FIG. 2A shows the data flow between computer system components in a first operating state of the invention. In this embodiment, the present invention provides a configurable link 232 communicatively coupled to an I/O Hub 230 and a Peripheral Device 234 which permits two, or more, levels of access depending upon the state of the Processing System 200.

In one embodiment of the present invention, the Processing System 200 is communicatively coupled to the I/O Hub 230 via a Hub bus 212, and functions as the default bus master for the I/O Hub 230 and peripheral devices 216, 218, and 234.

While the Processing System 200 operates as the default bus master, the Peripheral Device 234 operates as a “slave”. “Slave” mode is herein defined as a mode of operation in which the Peripheral Device 234 relies on the Processing System's 200 oversight to receive and/or transmit information. While in slave mode, the Peripheral Device 234 behaves as a conventional peripheral device, the Processing System 200 managing communications and/or message routing to the computer and other peripheral devices via the I/O Hub 230. The configurable link or link 232, operating in a first access level, may function as any conventional link or bus coupling the Peripheral device 234 to the Processing System 200. In one embodiment, in the first access level the configurable link 232 may be configured to operate at a different transfer rate than the I/O Hub bus 212.

FIG. 2B shows the data flow between the computer system components in a second access level or operating state of the invention. Typically, when the Processing System 200 is in certain power management states or sleeping states, peripheral devices cannot communicate with the computer or with each other because there is no master to manage communications or route data. However, in the second access level, the configurable link 232 allows a Peripheral Device 234 to function as the default bus master thereby managing communications over the I/O Hub 230.

The Peripheral Device 234 may be an autonomous subsystem which may remain powered even when other peripheral devices are put to sleep or into a suspended state. In the second access level, the configurable link 232 may permit a Peripheral Device 234 to manage communications to, from, and among other peripheral devices 216 and 218 via the I/O Hub 230. The Peripheral Device 234 may also receive, transmit, and/or buffer data without the assistance or reliance on the Processing System 200.

In order for the Peripheral Device 234 to operate as the default bus master, the configurable link 232 may be reconfigured for this purpose. Switching between the first and second access levels may entail reconfiguring the interface between the Peripheral Device 234 and configurable link 232, the link 232, the interface between the configurable link 232 and the I/O Hub 230, and/or the I/O Hub 230. This reconfiguration may result in the link 232 operating at a different transmission rate in the second access level than in the first access level.

Typically, I/O hubs are not designed to operate with two default bus masters. However, in one embodiment of the present invention, the I/O Hub 230 may be capable of operating with two alternative default bus masters. To achieve such operation, the I/O Hub 230 may comprise two bus interfaces capable of coupling to devices or components that may operate as default bus masters. At least one of the interfaces may be capable of being dynamically configured between a first and second access level or operating state. The I/O Hub 230 may also be modified to enable the operation of alternative default bus masters.

According to one embodiment of the invention, by monitoring the sleeping states or power management states of the processing system, the Peripheral Device 234 may be capable of changing its operating state from a conventional peripheral device (slave) to operating as the default bus master. As the default bus master, the Peripheral Device 234 may be capable of directly communicating with other peripheral devices 216 and 218.

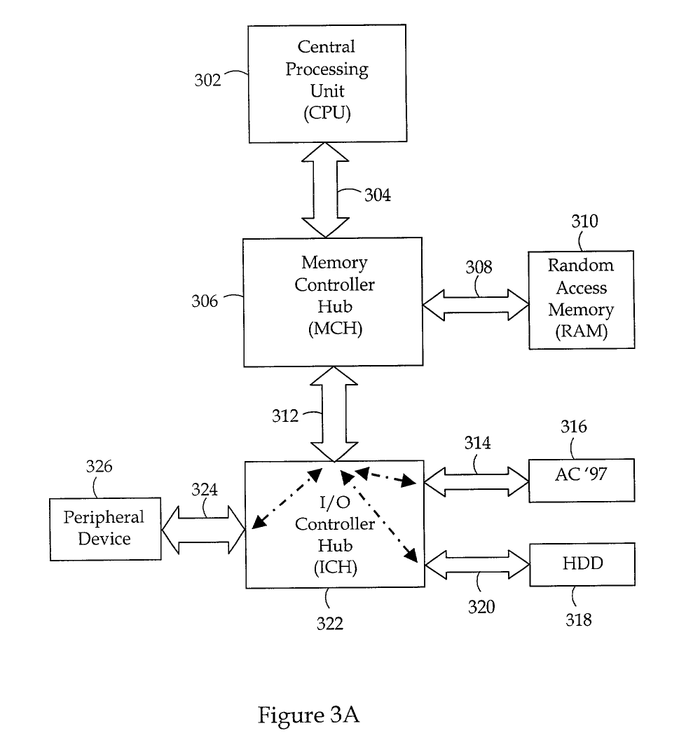

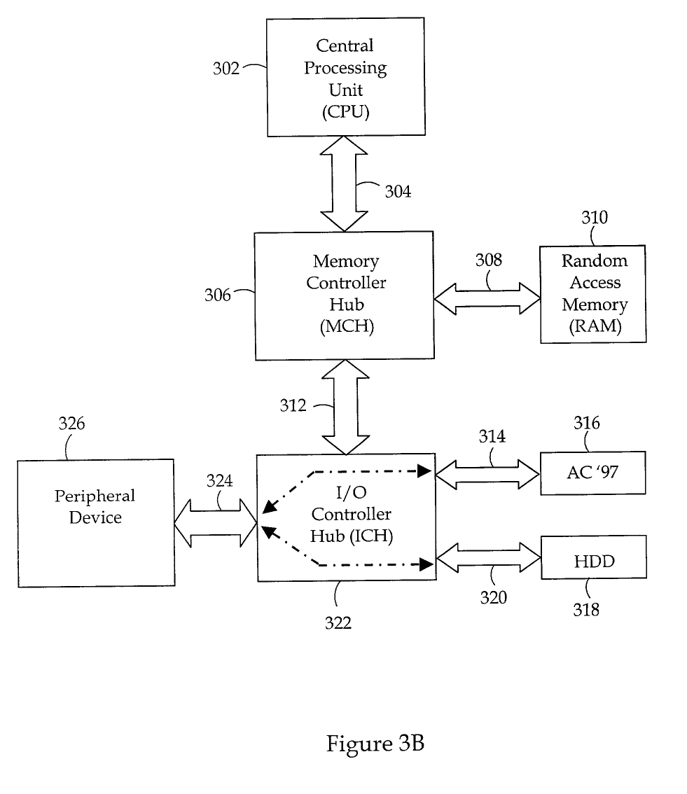

FIG. 3A illustrates another embodiment of the present invention, in the PC computer architecture, providing a configurable link 324 between an ICH 322 and a Peripheral Device 326 which permits two, or more, levels of access depending upon the state of the CPU 302.

According to one embodiment, shown in FIG. 3A, the computer's CPU 302 acts as the default bus master, communicating with the ICH 322 via the Hub Link bus 312. While the CPU 302, executing an operating system, acts as the default bus master, the configurable link 324 is configured to a first access level or state of operation thereby communicatively coupling the Peripheral Device 326 to the ICH 322. The Peripheral Device 326, operating in slave mode, behaves as a conventional peripheral device. The ICH 322 routes messages to the MCH 306 thus allowing the Peripheral Device 326 to communicate with the computer or other peripheral devices 310, 316, and 318. The ICH 322 and MCH 306 in turn rely on the CPU 302 to manage data flow. In this mode, direct communications between peripheral devices is not possible without the aid of the MCH 306 and/or the CPU 302.

According to one embodiment of the invention, the configurable link 324 is in a first access level and the Peripheral Device 326 is in slave mode if the CPU 302 is in power management states S0-S2 as defined in the ACPI specification.

From the host computer's point of view, the configurable link 324 operates as a conventional interface communicatively coupling the Peripheral Device 326 to the CPU 302. The Peripheral Device 326 in turn may behave as a conventional input/output (I/O) device. However, the Peripheral Device 326 is not limited to being an I/O component or peripheral device, it may be any internal or external autonomous component capable of operating as described herein. In one embodiment of the present invention, the Peripheral Device 326 may be a component mounted on the same motherboard as the CPU 302.

In one embodiment of the present invention, the Peripheral Device 326 is a wireless communication component which communicates with Bluetooth-compliant devices via a radio-link and interfaces with the host computer via the ICH 322.

FIG. 3B illustrates the present invention when the CPU 302 has entered a sleeping state and is unavailable to manage communications over the ICH 322. Typically, when the CPU 302 is in certain sleeping states, peripheral devices cannot communicate with the computer or with each other because there is no default bus master for the ICH 322 to route data. When the ICH 322 is itself placed into certain sleeping states by the CPU 302, it is no longer able to function.

In one embodiment, by monitoring the sleeping states or power management states of the CPU 302, the Peripheral Device 326 may be capable of configuring the link 324 to operate in a second level of access. The Peripheral Device 326 may operate in master mode, becoming the default bus master when the CPU 302 enters certain sleeping states. Thus, with the link 324 operating at a second access level, the Peripheral Device 326 may manage communications with other peripheral devices 310, 316, and 318 over the ICH 322 and/or MCH 306 without the assistance or reliance on the CPU 302. As noted above, the Peripheral Device 326 may be an autonomous subsystem which may remain powered even when other peripheral devices are put to sleep or into a suspended state by the CPU 302.

According to one embodiment of the invention, whether or not the Peripheral Device 326 remains On or operates in master mode when the CPU 302 is in a sleeping state, may be a configurable feature. This may be accomplished by the CPU 302, while still awake, configuring the Peripheral Device 326 to prevent it from entering into master mode.

In another embodiment of the present invention, the power management states during which the link 324 operates at a first or second access levels and the Peripheral Device 326 operates in master or slave modes may vary. For instance, in one embodiment, the link 324 may be configured to a first access level and the Peripheral Device 326 may operate in slave mode during power management states S0-S2, as defined in the ACPI specification. Accordingly, the link 324 may be configured to a second access level and the Peripheral Device 326 may operate in master mode during power management states S3-S5. In another embodiment, the link 324 may be configured to a first access level and the Peripheral Device 326 may be in slave mode during power management states SO-SI. Accordingly, during power management states S2-S5, the link 324 may operate at a second access level and the Peripheral Device 326 may operate in master mode.

The Peripheral Device 326 may detect when the CPU 302 goes into a power management state in a number of ways. In one embodiment of the present invention, the Peripheral Device 326 tests the CPU's 302 control lines or hardware pins to determine when a change in the operating state has occurred. In another embodiment of the present invention, the Peripheral Device 326 may learn of the CPU's 302 change of state by receiving notification of such change from the CPU 302 itself or from a secondary component. According to another embodiment, the Peripheral Device 326 may determine when a change in the operating state has occurred by testing the control lines or hardware of an auxiliary component, such as a chipset component.

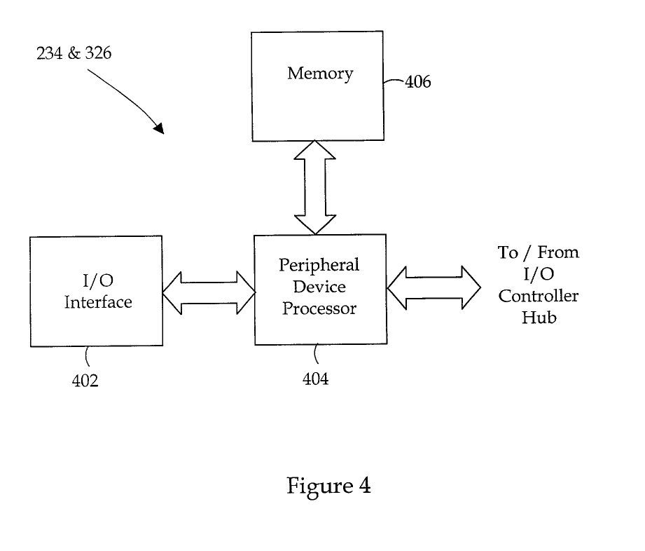

FIG. 4 is a system-level view of one embodiment of the Peripheral Device 234 (FIGS. 2A and 2B) or 326 (FIGS. 3A and 3B) according to the present invention. The Peripheral Device 234 or 326 may include a peripheral processor 404, an I/O interface 402, and memory 406. The Peripheral Processor 404 may be capable of hosting its own operating system.

The Peripheral Device 234 and 326 may be able to communicate with other peripheral devices 216 and 218 (FIGS. 2A and 2B) such as a HDD 318 or audio codec (AC '97) 316 (FIGS. 3A and 3B) while the Processing System 200 (FIGS. 2A and 2B) or CPU 302 (FIGS. 3A and 3B) is in a sleeping state. In order for the Peripheral Device 234 and 326 to communicate with other peripheral devices, it may interface to the I/O Hub 230 (FIGS. 2A and 2B) or ICH 322 (FIGS. 3A and 3B) via a configurable bus 232 (FIGS. 2A and 2B) and 324 (FIGS. 3A and 3B). In this manner, the Peripheral Device 234 and 326 may operate as the default bus master, allowing DMA bus mastering with the peripheral devices 216 and 218, such as AC '97 316 and HDD 318, and memory 406 and 310 (FIGS. 3A and 3B). This may require an I/O Hub 230 or ICH 322 capable of handling two or more default bus masters. However, the I/O Hub 230 or ICH 322 need not be able to accommodate two default bus masters simultaneously.

In one embodiment of the present invention, the Peripheral Device 326 may also be able to communicate with the main memory (RAM) 310 (FIGS. 3A and 3B) via the MCH 306. This may require modifying the existing MCH 306 to be able to operate when the CPU 302 is in certain sleeping states. In this manner, the Peripheral Device 326 may store data on RAM 310.

In master mode, the Peripheral Device 234 and 326 may also receive and/or transmit data over its I/O interface 402 and store and/or read data to and from memory 406. In this manner, the Peripheral Device 234 and 326 is able to buffer data destined for the computer and later deliver it to the computer when the Processing System 200 or CPU 302 awakens. The memory component 406 may be either internal to the Peripheral Device 234 and 326 or external to the Peripheral Device 234 and 326. In one embodiment of this invention, the Peripheral Device 234 and 326 may enable direct memory access (DMA) bus mastering between the I/O interface 402 and locally attached memory 406. In one embodiment of the invention, the I/O interface 402 may have a Bluetooth-compliant wireless component coupled to it.

In one embodiment of the present invention, the Peripheral Device 326 may receive data over its I/O interface 402 and transfer it to the audio codec (AC '97) 316 (FIGS. 3A and 3B) for processing while the CPU 302 is still in a sleeping state. In another embodiment of the invention, the Peripheral Device 326 may receive data and store it in the hard disk drive (HDD) 318 (FIGS. 3A and 3B) while the CPU 302 is in a sleeping state.

While in master mode, the Peripheral Device 234 and 326 may also have the capability to process some of the messages it receives. For instance, it may recognize the sender of a message and, when configured to do so, may alert the user by sending an alert message via the Peripheral Device's I/O interface 402 to another device, such as a Bluetooth-compatible cellular phone. Such configuration may be performed by the user via software running on the host computer's Processing System 200 (FIGS. 2A and 2B) or CPU 302 (FIGS. 3A and 3B) when it is awake.

The Peripheral Device 234 and 326 may also be able to awaken other peripheral devices 216 and 218 (FIGS. 2A and 2B), such as a hard disk drive 318 or AC '97 316 (FIGS. 3A and 3B), which may have been previously set to a sleeping state by the host computer's Processing System 200 or CPU 302. Such operation may require an I/O Hub 230 (FIGS. 2A and 2B) or ICH 322 (FIGS. 3A and 3B) that has added functionality to permit the Peripheral Device 234 and 326 to become the default bus master.

The Peripheral Device 234 and 326 may further identify when the Processing System 200 or CPU 302 is in a sleeping state or returning from a sleeping state. This may be accomplished in a number of ways. In one embodiment of the present invention, the Peripheral Device 234 and 326 monitors the Processing System 200 or CPU 302 to detect its operational state. If the Peripheral Device 234 and 326 is in the middle of an operation when the Processing System 200 or CPU 302 returns from a sleeping state, it may prevent the computer's Processing System 200 or CPU 302 from communicating with peripheral devices until the Peripheral Device 234 and 326 has finished its operation. This may be accomplished by delaying the Processing System 200 or CPU 302 from returning from its sleeping state until operations have been completed. In one embodiment of the present invention, the Peripheral Device 234 and 326 may prevent the Processing System 200 or CPU 302 from awakening or becoming the default bus master until it has finished its operation by directly operating upon the Processing System's 200 or CPU's 102 control lines. In another embodiment of the invention, the Peripheral Device 234 and 326 may delay the Processing System 200 or CPU 302 from awakening by acting through a secondary component to cause such delay.

The Peripheral Device 234 and 326 may also have power management states, allowing it to conserve power while in master mode by setting the Processing System 200 or CPU 302 to a suspended or sleeping state when not operating. Additionally, the Peripheral Device 234 and 326 may be capable of placing other peripheral devices into a sleeping state. In another embodiment of this invention, the Peripheral Device 234 and 326 may place the I/O component attached to the I/O interface 402 into a sleeping state while the I/O component is not receiving or transmitting.

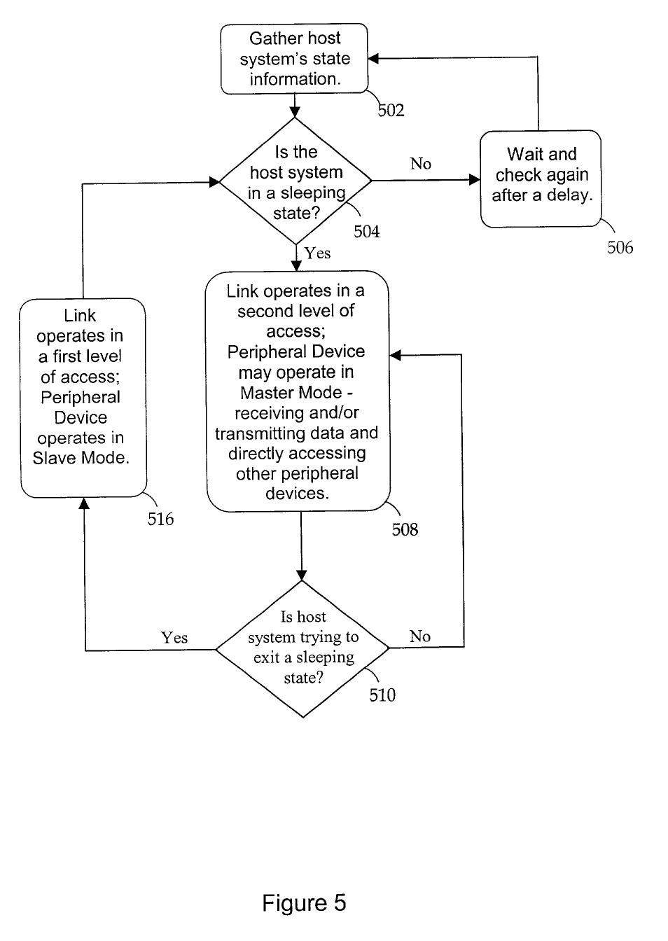

FIG. 5 is a high-level flowchart of the invention as has been described herein. This flowchart is intended to be exemplary of the way the present invention operates and variations upon these steps are possible and some have been described above. The following methods may be implemented in various systems or subsystem, and/or in hardware and/or software components.

According to one method of practicing the invention, the operating state of a host system, computer, or processing system is monitored to determine a change in the power management state 502.

Based on the information gathered about the system's power management state, a determination is made as to whether the system is in a sleeping state 504. Note that a “sleeping state” is not inclusive of every sleeping state possible. Rather the term may be used to denote a subset of the possible sleeping states, such as ACPI sleeping states S2-S5 for instance.

When a transition to a sleeping state is detected, a configurable link 232 and 324, coupled to the system, such as the ones shown in FIGS. 2A, 2B, 3A, and 3B may change from a first access level to a second access level 508. An autonomous subsystem or peripheral device, coupled to the configurable link 232, operating in master mode, may then function as the default bus master, directly communicating with other peripheral devices via the link 508. In this mode, the Peripheral Device 234 and 326 may also receive and/or transmit data and store or buffer it in memory 406 (FIG. 4) as described above.

The system's power management state shall continue to be monitored. In one embodiment, a determination is made as to whether the system is trying to exit a sleeping state 510. In another embodiment, a determination is made as to whether the system's power management state has changed. If so, then the link may be set to a first access level 516. The autonomous system or peripheral device may also change to operate in slave mode 516.

In one embodiment, the Peripheral Device 234 and 326 illustrated in FIGS. 2A, 2B, 3A, 3B, and 4, monitors transitions to and from power management states. In particular, it can determine whether or not the system continues to be in a sleeping state. If the system remains in a sleeping state, the Peripheral Device 234 and 326 may continue to operate in master mode.

In another embodiment, if the Processing System 200 (FIGS. 2A and 2B) or CPU 302 (FIGS. 3A and 3B) is awakening from its sleeping state, the Peripheral Device 234 and 326 may determine if it is in the middle of an operation, such as reading or writing to another peripheral device. If it is not in the middle of such operation, it can return to slave mode and the Processing System 200 or CPU 302 may awaken. However, if the Peripheral Device 234 and 326 is in the middle of an operation, it may delay the system from awakening until it has time to finish its operation. When the Peripheral Device 234 and 326 has finished, it can then return to slave mode and the Processing System 200 or CPU 302 can awaken.

A person of ordinary skill in the art will recognize that the present invention may be practiced on computer architectures other than the ones described herein. Additionally, the invention herein described may take the form of machine-readable instructions within the Peripheral Device 234 and 326. The instructions may be stored in any number of memory storage component or program stores, such as read-only memory modules.

While the Peripheral Device 234 and 326 may be mounted on the same motherboard as the host computer's Processing System 200 or CPU 302, the Peripheral Device 234 and 326 may also be an external component not mounted on the motherboard.

The ACPI power management states herein employed, S0-S5, are not a limitation on the present invention. Other states of operation, not limited to the power management states herein described, may be used to define the master and slave modes of operation for the Peripheral Device 234 and 326 without altering the nature of the invention.

While the invention has been described and illustrated in detail, it is to be clearly understood that this is intended by way of illustration and example only and is not to be taken by way of limitation, the spirit and scope of this invention being limited only by the terms of the following claims.

What is claimed is:

1. An apparatus comprising:
a configurable link which permits
a first level of access if a computer's central processing unit (CPU) is in a first power management state; and
a second level of access if the computer's CPU is in a second power management state.

2. The device of claim 1, wherein the first power management state and the second power management state each comprises a set of power management states.

3. The apparatus of claim 1, further comprising:
a first peripheral device communicatively coupled to the configurable link wherein the first level of access the peripheral device is capable of operating as a conventional peripheral device.

4. The apparatus of claim 1, further comprising:
a first peripheral device communicatively coupled to the configurable link wherein the second level of access the peripheral device is capable of operating as the default bus master for the computer without assistance from the CPU.

5. The apparatus of claim 4, wherein a peripheral device coupled to the configurable link causes the configurable link to operate in the second level of access when the CPU is in a second power management state

6. The apparatus of claim 1, wherein the second power management state the computer's CPU is in a sleeping state.

7. The apparatus of claim 1, wherein the second power management state includes power modes S3-S5 as defined in the Advanced Configuration and Power Interface (ACPI) specification.

8. The apparatus of claim 1, wherein the second level of access the transfer rate over the configurable link is different than in the first level of access.

9. The apparatus of claim 1, further comprising:
a first peripheral device coupled to the configurable link; and
an input/output hub communicatively coupling the configurable link and the central processing unit (CPU).

10. The apparatus of claim 9, wherein the first level of access, the CPU manages the input/output hub to control communications to and from the first peripheral device.

11. The apparatus of claim 9, wherein the second level of access, the configurable link enables the first peripheral device to manage the input/output hub to control communications to and from the first peripheral device.

12. The apparatus of claim 9, further comprising a second peripheral device communicatively coupled to the input/output hub.

13. The apparatus of claim 12, wherein the second level of access, the first peripheral device can communicate directly with the second peripheral device without assistance from the CPU.

14. A method comprising:
configuring a link to provide a first level of access to a computer's resources if the computer's central processing unit (CPU) is in a first power management state; and
configuring the link to provide a second level of access to the computer's resources if the computer's CPU is in a second power management state.

15. The method of claim 14, further comprising:
coupling a peripheral device to the configurable link wherein the second level of access the peripheral device is capable of operating as the default bus master for the computer.

16. The method of claim 15, wherein the first level of access the peripheral is capable of operating as a conventional peripheral device.

17. The method of claim 14, wherein the second power management state the computer's CPU is in a sleeping state.

18. The method of claim 14, wherein the second power management state includes power modes S3-S5 as defined in the Advanced Configuration and Power Interface (ACPI) specification.

19. The method of claim 14, wherein a peripheral device coupled to the configurable link causes the configurable link to operate in the second level of access when the CPU is in a second power management state.

20. The method of claim 14, wherein configuring the link to provide a second level of access also requires configuring an input/output hub to which the link couples to allow the peripheral device to become the default bus master.

21. A system, comprising:
a sub-system to detect the power management state of a central processor;
a sub-system to determine whether the central processor is in a first power management state or a second power management state;
a sub-system to allow the central processor to manage data flow over an input/output hub if the central processor is in a first power management state; and
a sub-system to configure a link coupling the input/output hub to a first peripheral device to allow the first peripheral device to manage data flow over the hub if the central processor is in a second power management state.

22. The system of claim 21, further comprising:
a sub-system to initiate a data transfer from the first peripheral device if the central processor is in the second power management state.

23. The system of claim 21, further comprising:
a sub-system to buffer data at the first peripheral device if the central processor is in the second power management state.

24. The system of claim 21, further comprising:
a sub-system to allow the first peripheral device to directly access and communicate with a second peripheral device without assistance from the central processor.

25. The system of claim 21, further comprising:
a sub-system to delay the central processor from transitioning from the second power management state to the first power management state.
